(19) United States
(12) Patent Application Publication
(10) Pub. No.: US 2021/0040748 A1
(43) Pub. Date: Feb. 11, 2021

(54) Floor Installation Tapper Apparatus

(71) Applicant: Raymond Pokraka, Nottawa (CA)

(72) Inventor: Raymond Pokraka, Nottawa (CA)

(21) Appl. No.: 16/532,898

(22) Filed: Aug. 6, 2019

(51) Int. Cl. E04F 21/20; B25G 1/10

(52) U.S. Cl. CPC E04F 21/20; B25G 1/10

(57) ABSTRACT

A floor installation tapper apparatus for improved flooring installation includes a principal block and a handle block. The principal block is rectangular prismatic and has a principal front side, a principal back side, a principal left side, a principal right side, a principal top side, and a principal bottom side. The handle block is coupled to the principal top side. The handle block is rectangular prismatic with a handle front side and a handle back side each lying in planes lying parallel to planes of the principal front side and the principal back side, a handle left side and a handle right side each lying in planes lying parallel to planes of the principal left side and the principal right side, and a handle top side lying in a plane parallel to a plane of the principal top side.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to floor installation tools and more particularly pertains to a new floor installation tool for improved flooring installation.

### BRIEF SUMMARY OF THE INVENTION

An embodiment of the disclosure meets the needs presented above by generally comprising a principal block and a handle block. The principal block is rectangular prismatic and has a principal front side, a principal back side, a principal left side, a principal right side, a principal top side, and a principal bottom side. The handle block is coupled to the principal top side and has a handle front side, a handle back side, a handle left side, a handle right side, and a handle top side. The handle block is rectangular prismatic with the handle front side and the handle back side each lying in planes lying parallel to planes of the principal front side and the principal back side, the handle left side and the handle right side each lying in planes lying parallel to planes of the principal left side and the principal right side, and the handle top side lying in a plane parallel to a plane of the principal top side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a floor installation tapper apparatus according to an embodiment of the disclosure.

FIG. 2 is a front elevation view of an embodiment of the disclosure.

FIG. 3 is a side elevation view of an embodiment of the disclosure.

FIG. 4 is a bottom plan view of an embodiment of the disclosure.

### DETAILED DESCRIPTION OF THE INVENTION

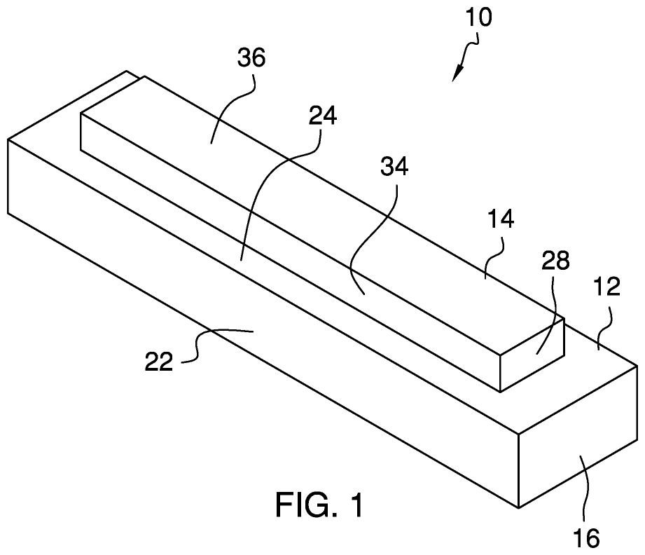

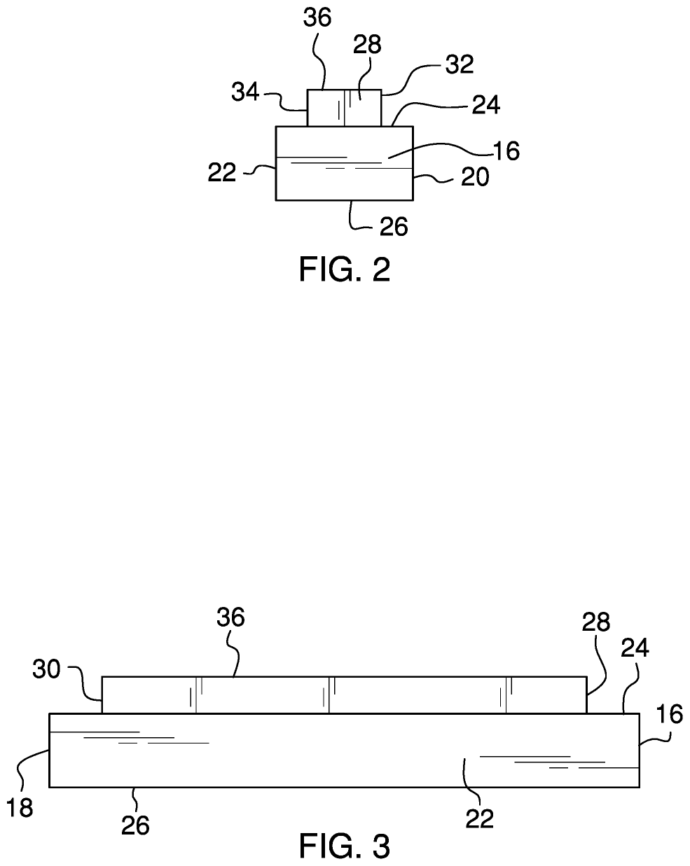

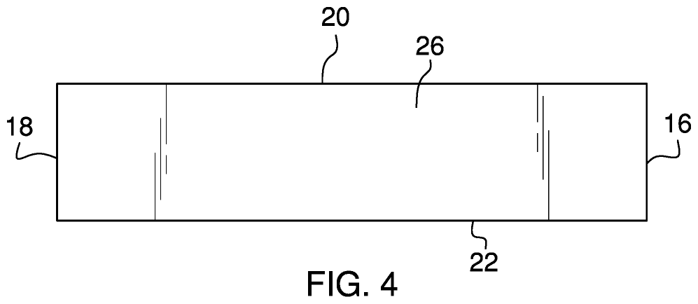

With reference now to the drawings, and in particular to FIGS. 1 through 4 thereof, a new floor installation tool embodying the principles and concepts of an embodiment of the disclosure and generally designated by the reference numeral 10 will be described.

As best illustrated in FIGS. 1 through 4, the floor installation tapper apparatus 10 generally comprises a principal block 12 and a handle block 14. The principal block 12 is rectangular prismatic and has a principal front side 16, a principal back side 18, a principal left side 20, a principal right side 22, a principal top side 24, and a principal bottom side 26. The handle block 14 is coupled to the principal top side 24 and is centrally disposed on the principal top side 24. The handle block 14 has a handle front side 28, a handle back side 30, a handle left side 32, a handle right side 34, and a handle top side 36. The handle block 14 is rectangular prismatic with the handle front side 28 and the handle back side 30 each lying in planes lying parallel to planes of the principal front side 16 and the principal back side 18. The handle left side 32 and the handle right side 34 each lie in planes lying parallel to planes of the principal left side 20 and the principal right side 22. The handle top side 36 lies in a plane parallel to a plane of the principal top side 24. A handle length 38 of the handle block is between 80-85% of a principal length 40 of the principal block and a handle width 42 of the handle block is between 50-55% of a principal width 44 of the principal block. A handle height 46 of the handle block is equal to 50% of a principal height 48 of the principal block. The handle length 38 is ideally 11.5 inches and the principal length 40 is ideally 14 inches. The handle width 42 is ideally 1.75 inches and the principal width 44 is ideally 3.25 inches. The handle height 46 is ideally 0.875 inches and the principal height 48 is ideally 1.75 inches.

In use, the handle block 14 is secured to use the principal block 12 to tap flooring material into place.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A floor installation tapper apparatus comprising:
a principal block, the principal block being rectangular prismatic and having a principal front side, a principal back side, a principal left side, a principal right side, a principal top side, and a principal bottom side; and
a handle block coupled to the principal block, the handle block being coupled to the principal top side, the handle block having a handle front side, a handle back side, a handle left side, a handle right side, and a handle top side, the handle block being rectangular prismatic with the handle front side and the handle back side each lying in planes lying parallel to planes of the principal front side and the principal back side, the handle left side and the handle right side each lying in planes lying parallel to planes of the principal left side and the principal right side, the handle top side lying in a plane parallel to a plane of the principal top side.

2. The floor installation tapper apparatus of claim 1 further comprising the handle block being centrally disposed on the principal top side.

3. The floor installation tapper apparatus of claim 1 further comprising a handle length of the handle block being between 80-85% of a principal length of the principal block.

4. The floor installation tapper apparatus of claim 1 further comprising a handle width of the handle block being between 50-55% of a principal width of the principal block.

5. The floor installation tapper apparatus of claim 1 further comprising a handle height of the handle block being equal to 50% of a principal height of the principal block.

6. A floor installation tapper apparatus comprising:
a principal block, the principal block being rectangular prismatic and having a principal front side, a principal back side, a principal left side, a principal right side, a principal top side, and a principal bottom side; and
a handle block coupled to the principal block, the handle block being coupled to the principal top side, the handle block being centrally disposed on the principal top side, the handle block having a handle front side, a handle back side, a handle left side, a handle right side, and a handle top side, the handle block being rectangular prismatic with the handle front side and the handle back side each lying in planes lying parallel to planes of the principal front side and the principal back side, the handle left side and the handle right side each lying in planes lying parallel to planes of the principal left side and the principal right side, the handle top side lying in a plane parallel to a plane of the principal top side, a handle length of the handle block being between 80-85% of a principal length of the principal block, a handle width of the handle block being between 50-55% of a principal width of the principal block, and a handle height of the handle block being equal to 50% of a principal height of the principal block.
